(19) United States
(12) Patent Application Publication
(10) Pub. No.: US 2012/0274216 A1
(43) Pub. Date: Nov. 1, 2012

(54) SELECTIVELY ACTIVATED RAPID START/BLEEDER CIRCUIT FOR SOLID STATE LIGHTING SYSTEM

(75) Inventor: Michael Jay Datta, Brookline, MA (US)

(73) Assignee: KONINKLIJKE PHILIPS ELECTRONICS, N.V., Eindhoven (NL)

(21) Appl. No.: 13/501,258

(22) PCT Filed: Oct. 20, 2010
(86) PCT No.: PCT/IB10/54754

§ 371 Date: Apr. 11, 2012

Related U.S. Application Data
(60) Provisional application No. 61/256,634, filed on Oct. 30, 2009.

(51) Int. Cl. H05B 37/02

(52) U.S. Cl. 315/127

(57) ABSTRACT

A device controls current drawn by a solid state lighting (SSL) fixture, including a power converter and an SSL load. The device includes a rapid start/bleeder circuit having a selectable low impedance path, configured to be temporarily activated to form a low impedance connection between a voltage rectifier and the power converter providing power to the SSL load. The low impedance path is temporarily activated during a start-up period to charge the power converter and during times other than the start-up period based on detected improper operation of the SSL fixture.

The present application relates to U.S. Provisional Application No. 60/247,297, filed Sep. 30, 2009, entitled “Rapid Start-Up Circuit for Solid State Lighting System” and incorporated herein by reference.

### TECHNICAL FIELD

The present invention is directed generally to multi-tasking rapid start-up circuits for solid state lighting systems. More particularly, various inventive devices and methods disclosed herein relate to selectively providing a low impedance path of a rapid start-up circuit for use with a dimming circuit in a solid state lighting system at times other than during a start-up period.

### BACKGROUND

Solid state lighting technologies, i.e., illumination based on semiconductor light sources, such as light-emitting diodes (LEDs) and organic light-emitting diodes (OLEDs), offer a viable alternative to traditional fluorescent, high-intensity discharge (HID), and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications.

Some of the fixtures embodying these sources feature a lighting module, including one or more LEDs capable of producing white light and/or different colors of light, e.g., red, green and blue, as well as a controller or processor for independently controlling the output of the LEDs in order to generate a variety of colors and color-changing lighting effects, for example, as discussed in detail in U.S. Pat. Nos. 6,016,038 and 6,211,626, incorporated herein by reference. LED technology includes line voltage powered white lighting fixtures, such as the EssentialWhite™ series, available from Philips Color Kinetics.

Many lighting applications make use of dimmers. Conventional dimmers work well with incandescent (bulb and halogen) lamps. However, problems occur with other types of electronic lamps, including compact fluorescent lamp (CFL), low voltage halogen lamps using electronic transformers and solid state lighting (SSL) lamps or units, such as LEDs and OLEDs, or other loads. Low voltage SSL units using electronic transformers, in particular, may be dimmed using special dimmers, such as, for example, electric low voltage (ELV) type dimmers or resistive-capacitive (RC) dimmers.

Conventional dimmers typically chop a portion of each waveform (sine wave) of the mains voltage signal and pass the remainder of the waveform to the lighting fixture. A leading edge or forward-phase dimmer chops the leading edge of the voltage signal waveform. A trailing edge or reverse-phase dimmer chops the trailing edge of the voltage signal waveform. Electronic loads, such as LED drivers, typically operate better with trailing edge dimmers.

Unlike incandescent and other resistive lighting devices which respond naturally without error to a chopped waveform produced by a dimmer, LED and other SSL units or fixtures have a noticeable delay and/or flicker from when a user switches on the light fixture to when the light actually turns on. This delay from when the physical power switch on the SSL unit or fixture is turned on to when light is first seen from the fixture may be undesirably long. The cause of this delay is the time it takes for the power converter to have enough voltage to start up and begin converting power from the unrectified line voltage to power the SSL unit or fixture according to the dimmer setting. The time delay is determined by various factors, such as the available rectified voltage (Urect), e.g., as determined by the chopped waveform of the mains voltage signal based on dimmer setting, the impedance from the node Urect to the node Vcc, which supplies power to the power converter integrated circuit (IC), and the capacitance from the node Vcc to ground.

To address this delay, so-called “instant start” circuits have been developed. However, relatively low dimmer settings used in combination with instant start circuits still result in noticeable delay from the time the switch is flipped to turn on the SSL unit or fixture to the time light is seen. For example, an instant start circuit may be passive, e.g., consisting of an RC circuit. Generally, the lower the impedance of the start-up network, the faster the power converter will turn on. However, with the passive RC start-up network, steady state power loss increases with faster turn-on time, which results in lower power supply efficiency and thus lower overall fixture efficacy (e.g., lumens per watt).

In addition, compatibility issues exist between dimmers and non-resistive loads following the start-up period, particularly due to low power of SSL loads. Examples of compatibility issues include misfiring of dimmer electronic switches, providing supply voltage to the power converter during low dimmer levels and discharging the system input capacitors.

With respect to misfiring of dimmer electronic switches, in particular, when the dimmer electronic switch is closed (turned on), a voltage is applied to the output of the dimmer, and when the dimmer switch is open (turned off), no voltage is applied to the output of the dimmer Different types of electronic switches may be used in conventional dimmers. For example, a TRIAC (TRIode Alternating Current) switch may be used, which requires a minimum holding current and/or latching current to stay turned on in order to output the dimmer voltage. However, low-wattage loads, such as LED lamps and other SSL units and fixtures, often fail to draw this minimum current. When the minimum current is not drawn, the TRIAC switches incorrectly (e.g., misfires), resulting in improper operation of the dimmer/SSL unit or fixture system. Such improper operation can result in undesirable effects, such as flicker.

Thus, there is a need for an instant start circuit that that provides sufficient power to the power converter IC of a solid-state lighting unit or fixture over a range of dim levels, and particularly at comparatively low dim levels.

### SUMMARY

The present disclosure is directed to inventive methods and devices for selectively implementing low impedance paths of a rapid start-up circuit of a power converter for solid state lighting units and fixtures, acting as a bleeder and improving compatibility, during the start-up period and during periods other than the start-up period, during which the solid state lighting units or fixtures are drawing insufficient current for proper operation of the dimmer/SSL system.

Generally, in one aspect, a device is provided to control current drawn by a solid state lighting (SSL) fixture, including a power converter and an SSL load. The device includes a rapid start/bleeder circuit having a selectable low impedance path, configured to be temporarily activated to form a low impedance connection between a voltage rectifier and the power converter providing power to the SSL load. The low impedance path is temporarily activated during a start-up period to charge the power converter and during times other than the start-up period based on detected improper operation of the SSL fixture.

In another aspect, a system is provided for powering an SSL load, the system including a dimmer circuit, a rectifier circuit, a power converter, a rapid start/bleeder circuit and a controller. The dimmer circuit is configured to adjust a voltage of the SSL load. The rectifier circuit is configured to rectify the adjusted voltage output by the dimmer circuit. The power converter is configured to provide power to the SSL load based on the rectified voltage output by the rectifier circuit. The rapid start/bleeder circuit includes a low impedance path, configured to form a low impedance connection between the rectifier circuit and the power converter when activated. The controller is configured to selectively activate the low impedance path of the rapid start/bleeder circuit during a start-up period to charge the power converter and during times other than the start-up period based on current drawn by the SSL load.

In another aspect, a system is provided that includes a dimmer, a rectifier, an SSL fixture, a rapid start/bleeder circuit and a controller. The dimmer is configured to adjust an input voltage. The rectifier is configured to rectify the adjusted voltage output by the dimmer circuit. The SSL fixture includes a power converter and an SSL load, where the power converter provides power to the SSL load based on the rectified voltage output by the rectifier. The rapid start/bleeder circuit includes a low impedance path, configured to form a low impedance connection between the rectifier circuit and the power converter when activated. The controller is configured to monitor operation of the SSL fixture and to selectively activate the low impedance path of the rapid start/bleeder circuit during a start-up period to charge the power converter and during times other than the start-up period based on the monitoring of the SSL fixture operation.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., LED white lighting fixture) may include a number of dies which respectively emit different spectra of electroluminescence that, in combination, mix to form essentially white light. In another implementation, an LED white light fixture may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum. It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white light LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor and/or controller may be associated with one or more storage media (generically referred to herein as “memory,” e.g., volatile and non-volatile computer memory such as random-access memory (RAM), read-only memory (ROM), programmable read-only memory (PROM), electrically programmable read-only memory (EPROM), electrically erasable and programmable read only memory (EEPROM), universal serial bus (USB) drive, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same or similar parts throughout the different views. Also, the drawings are not necessarily to scale, emphasis instead generally being placed upon illustrating the principles of the invention.

FIG. 1 is a block diagram showing a rapid start circuit, according to a representative embodiment.

FIG. 2 is a block diagram showing a rapid start circuit, according to a representative embodiment.

FIG. 3 is a block diagram showing a rapid start circuit multitasking as a bleeder circuit, according to a second representative embodiment.

FIGS. 4A and 4B show chopped, rectified voltage waveforms output by a dimmer connected to a low power solid state lighting unit or fixture.

FIG. 5 is a block diagram showing a rapid start circuit multitasking as a bleeder circuit, according to a representative embodiment.

FIG. 6 is a block diagram showing a rapid start circuit multitasking as a bleeder circuit, according to a representative embodiment.

FIG. 7 is a flow diagram showing a process of implementing a low impedance path of a rapid start circuit as a bleeder circuit, according to a representative embodiment.

FIG. 8 is a block diagram showing a controller of a rapid start circuit multitasking as a bleeder circuit, according to a representative embodiment.

### DETAILED DESCRIPTION

In the following detailed description, for purposes of explanation and not limitation, representative embodiments disclosing specific details are set forth in order to provide a thorough understanding of the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the present teachings.

Applicants have recognized and appreciated that it would be beneficial to provide a circuit capable of reducing the delay between activating a switch of a solid state lighting unit or fixture and the turn-on time, particularly at low dimmer settings. In other words, to provide rapid start capability of a power converter for solid state lighting units and fixtures at low dimmer settings. Applicants have further recognized and appreciated that it would be beneficial to use the circuit capable of reducing the delay between activating the switch and the turn-on time also as a bleeder circuit, which is selectively activated to provide a low impedance path, as needed, to enable proper operation of the dimmer/SSL system, including the solid state lighting units and fixtures, at times other than start-up, as well as during start-up.

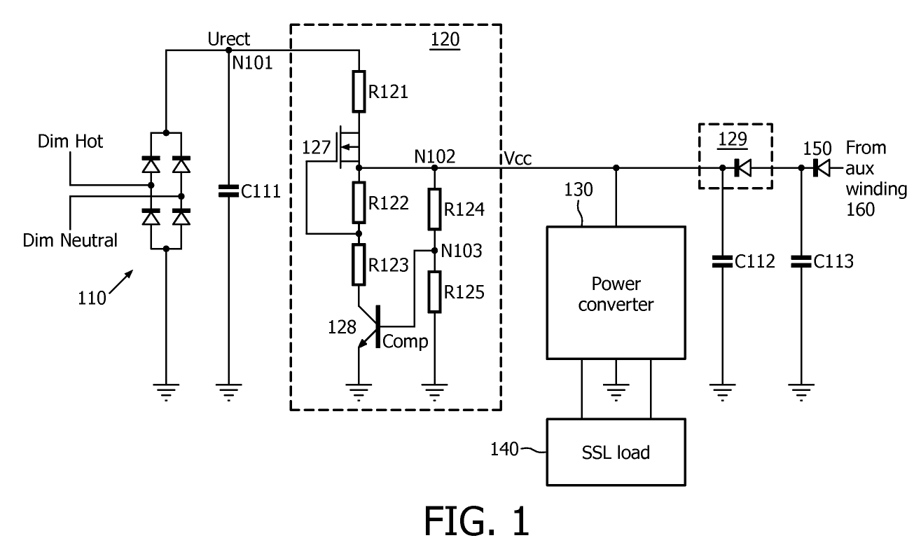

FIG. 1 is a block diagram showing a rapid start circuit for powering a solid state lighting system, which can be multitasked as a selectively activated bleeder circuit, according to various embodiments of the invention. Referring to FIG. 1, rapid start circuit 120 includes first (depletion) transistor 127, second transistor 128, representative resistors 121-125 and diode 129 (shown separately). For purposes of the following explanation, the first transistor 127 is a field-effect transistor (FET) and the second transistor is a bipolar junction transistor (BJT), although other types of transistors may be implemented without departing from the scope of the present teachings. The rapid start circuit 120 provides voltage Vcc to power converter 130 (or power converter IC) so that the power converter 130 can start up more quickly during a start-up period, and begin delivering power from the mains to the SSL load 140.

The start-up period is the time it takes for auxiliary winding 160 to be fully charged and for the voltage Vcc to reach a steady state value. The auxiliary winding 160 provides voltage to Vcc node N102 when the power converter 130 is in steady state operation. However, the auxiliary winding 160 cannot be used to start up the power converter 130 when the power converter 130 is in the off state, so some other means, such as the rapid start circuit 120, is provided. The auxiliary winding 160 is typically taken as an extra winding off of the main power magnetic which the power converter 130 uses to convert power. The auxiliary winding 160 therefore uses a small fraction of the energy in the main winding to power the power converter 130. The SSL load 140 may be part of a solid state lighting unit or fixture (e.g., including the power converter 130) or other system, for example.

The rapid start circuit 120 receives (dimmed) rectified voltage Urect through diode bridge or bridge rectifier 110 from the dimmer (not shown) via Dim Hot and Dim Neutral. When a dimming setting has been selected, the rectified voltage Urect has leading edge or trailing edge chopped waveforms, the extent of which is determined by the selected extent of dimming, where low dimmer settings result in more significant waveform chopping and thus a lower RMS rectified voltage Urect. A rectified voltage Urect node N101 may be coupled to ground voltage through capacitor C111 (e.g., about 0.1 μF) in order to filter the switching current of the power converter IC. Notably, the various values provided throughout the description are illustrative, and may be determined depending on the particular situation or application specific design requirements of various implementations, such as use of U.S. voltages, E.U. voltages, or some other voltages, as would be apparent to one skilled in the art.

The rectified voltage Urect is connected through bridge rectifier 110 to a dimmer (not shown) via lines DIM hot and DIM neutral. The dimmer initially receives (undimmed) unrectified voltage from the power mains. Generally, the unrectified voltage is an AC line voltage signal having a voltage value, e.g., between about 90 VAC and about 277 VAC, and corresponding substantially sinusoidal waveforms. The dimmer includes an adjuster, which enables a dimming setting to be variably selected, e.g., manually by a user or automatically by a processor or other setting selection system. In an embodiment, the adjuster enables settings ranging from about 20 to 90 percent of the maximum light level of the SSL load 140. Also, in various embodiments, the dimmer is a phase chopping (or phase cutting) dimmer, which chops either the leading edges or trailing edges of the input voltage waveforms, thereby reducing the amount of power reaching the SSL load 140. For purposes of explanation, it is assumed the dimmer is a trailing edge dimmer, which cuts a variable amount of the trailing edges of the unrectified sinusoidal waveforms.

Generally, the rapid start circuit 120 temporarily creates a low impedance path from Urect node N101 to Vcc node N102 during the start-up period, which occurs when the auxiliary winding 160 is not yet fully charged (for powering the power converter 130) and the voltage Vcc has not yet reached a steady state value. For example, when the SSL load 140 is turned-on (e.g., via the dimmer adjuster or other physical switch), the initial voltage of the auxiliary winding 160 is zero, and will remain zero until the power converter 130 has a chance to start up during the start-up period. Power for start-up of the power converter 130 is drawn through R121 (e.g., about 22 kΩ) and the depletion first transistor 127 of the rapid start circuit 120 to charge capacitors C112 and C113. After the power converter 130 has started up, the auxiliary winding 160 provides the voltage Vcc to the power converter 130 through diode 150 and the first transistor 127 is made high impedance through activation of the second transistor 128, as discussed a below. The capacitor C112 provides a small bypass capacitance (e.g., about 0.1 μF) connected between Vcc node N102 and ground in order to shunt high frequency noise, and the capacitor C113 provides a large bulk capacitance (e.g., about 10 μF) connected between Vcc node N102 and ground, in order to provide lower frequency filtering and temporary hold up.

More particularly, at the beginning of the start-up period, a COMP signal received at the base of the second transistor 128 is initially low. In the depicted representative embodiment, the second transistor 128 also includes a collector connected to resistor R123 (e.g., about 100 kΩ) and an emitter connected to ground voltage. The low COMP signal turns off the second transistor 128, and thus the second transistor 128 is effectively open circuited. In the depicted embodiment, the COMP signal is provided through node N103, which is connected to voltage Vcc at Vcc node N102 through resistor R124 (e.g., about 100 kΩ) and to the ground voltage through resistor 125 (e.g., about 100 kΩ). The COMP signal is initially low because the voltage Vcc is low, since the rectified voltage Urect has not charged the auxiliary winding 160, and thus the voltage Vcc at Vcc node N102 is not yet at the steady state value. Because the second transistor 128 is turned off, the gate of the depletion first transistor 127 is connected to the source of the depletion first transistor 127, for example, through resistor R122 (e.g., about 100 kΩ). In this state, the impedance of the depletion first transistor 127 is low. A drain of the first transistor 127 is connected to Urect node N101 through resistor R121 (e.g., about 22 kΩ).

When the system is powered up, the rectified voltage Urect is high, and the voltage Vcc begins to charge through the resistor R121 and the first transistor 127. When the voltage Vcc is charged to the necessary voltage, the power converter 130 activates to power the SSL load 140, and the COMP signal is brought high. The high COMP signal turns on the second transistor 128, which connects the gate of the first transistor 127 to ground voltage through the resistor R123. In this state, the first transistor 127 is turned off, and its impedance becomes high, which effectively disconnects the rectified voltage Urect at Urect node N101 from the Vcc node N102. In other words, when the COMP signal is low, the rectified voltage Urect at Urect node N101 is connected to the Vcc node N202 through a low impedance, and when the COMP signal high, this low impedance is disconnected.

In addition, the rapid start circuit 120 includes the diode 129, which separates the large bulk capacitor C113 from the small bypass capacitor C112, thereby reducing the total capacitance from Vcc node N102 to ground during the start-up transient. In an embodiment, the diode 129 includes an anode connected to ground through the capacitor C113 and a cathode connected to ground through the capacitor C112.

When the mechanical switch on the dimmer (not shown) is turned on, the voltage from the auxiliary winding 160 is at or near ground voltage, assuming the SSL load 140 has been off for a sufficiently long time, and the diode 129 is reverse biased. Because the COMP signal is initially low, the second transistor 128 is turned off, and the gate and source of the first transistor 127 are connected, current is allowed to flow from rectified voltage Urect node N201 through the resistor R121 and the first transistor 127 to Vcc node N102, as discussed above, initially charging only the capacitor C112 and not the capacitor C113, which has been effectively removed from the circuit by the diode 129. Because the capacitor C112 is a small value capacitor used for bypassing Vcc node N202, the rapid start circuit 120 is able to charge the capacitor C112 to the operating voltage of the power converter 130 quickly, even when the rectified voltage Urect at Urect node N101 is very small, e.g., when the dimmer is at its lowest setting.

The large bulk capacitor C113 is not removed when Vcc is at the steady state voltage value, but only during the start-up period when the voltage at the auxiliary winding 160 is low. That is, in steady state, the diode 129 conducts, enabling capacitor C113 to be connected to the voltage Vcc at Vcc node N102, providing the ripple reducing benefits of a large bulk capacitor. In addition, once the power converter 130 has started running, the COMP signal goes high and the second transistor 128 is switched on, causing the first transistor 127 to turn off and thus effectively disconnecting the rectified voltage Urect at Urect node N101 from the Vcc node N102, as discussed above.

Accordingly, the diode 129 of the rapid start circuit 120 effectively switches out the large bulk capacitance of the capacitor C113 during the start up transient, but allows it to be connected during steady state operation. By disconnecting the capacitor C113 during start-up, the voltage Vcc can be charged up faster, enabling rapid start even when the rectified voltage Urect is very low, such as when a dimmer is at its lowest setting.

In various embodiments, the dimmer may be a two- or three-wire electronic low-voltage (ELV) dimmer, for example, such as Lutron Diva DVELV-300 dimmer, available from Lutron Electronics Co., Inc. The SSL load 140 may be an LED or OLED lighting unit or lighting system, for example. The various components shown in FIG. 1 may be arranged in different pre-packaged configurations that may differ from the depicted grouping. For example, the bridge rectifier 110, the rapid start circuit 120, the power converter 130 and the SSL load 140 may be packaged together in one product, such as EssentialWhite™, lighting fixture, available from Philips Color Kinetics. Various embodiments may include any type of the dimmer, lighting system and/or packaging, without departing from the scope of the present teachings.

The dimmer provides the dimmed rectified voltage (e.g., having chopped waveforms) to the power converter 130 though the bridge rectifier 100 and the rapid start circuit 120. The power converter 130 may include structure and functionality described, for example, in U.S. Pat. No. 7,256,554, to Lys, issued Aug. 14, 2007, the subject matter of which is hereby incorporated by reference.

The power converter 130 may be constructed of any combination of hardware, firmware or software architectures, without departing from the scope of the present teachings. For example, in various embodiments, the power converter 130 may implemented as a controller, such as a microprocessor, ASIC, FPGA, and/or microcontroller, such as an L6562 PFC controller, available from ST Microelectronics.

As stated above, when the dimmer is adjusted to a low setting, resulting in an RMS voltage of the dimmer output being fairly low (e.g., about 35V or less), there would typically not be enough energy transferred to the power magnetic for the auxiliary winding 160 to power the power converter 130, resulting in shut down. However, in accordance with the present embodiment, the low dimmer level is detected by the failing of voltage Vcc via the divider formed by the resistors R124 and R125, and the rapid start circuit 120 is activated via the COMP signal. Once the rapid start circuit 120 is activated, the power converter 130 is supplied from the rectified mains through the resistor R121 and the depletion first transistor 127 (e.g., implemented as a FET). When the first transistor 127 is switched in, the power converter 130 is able to run even during low dimmer levels, preventing negative start-up effects, such as delay and flickering. In other embodiments, the low dimmer level may be detected by an entity not depicted in FIG. 1, such as a controller or microcontroller, and the COMP signal may be controlled by this entity to activate or deactivate the rapid start circuit 120, as needed.

It is understood that, although representative values have been provided above for purposes of discussion, the values of the capacitors C111-C113 and the resistors R121-R125 are determined depending on the particular situation or application specific design requirements of various implementations, as would be apparent to one skilled in the art.

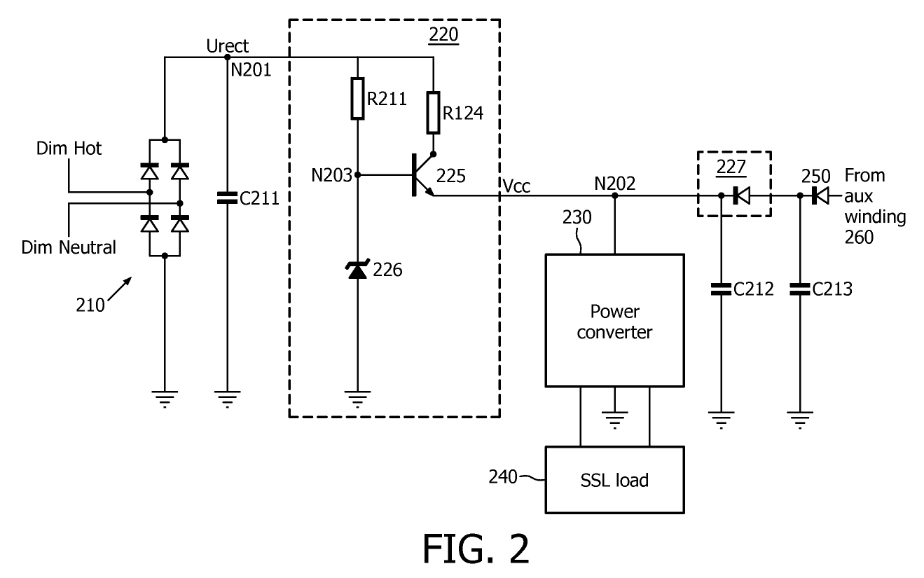

FIG. 2 is a block diagram showing a rapid start circuit for powering a solid state lighting system, which can be multitasked as a selectively activated bleeder circuit, according to another representative embodiment. Referring to FIG. 2, rapid start circuit 220 includes transistor 225, first diode 226, representative resistors 211-212 and second diode 227 (shown separately). For purposes of the following explanation, the transistor 225 is a BJT and the first diode is a zener diode, although other types of transistors and/or diodes may be implemented without departing from the scope of the present teachings. As discussed above with respect to the rapid start circuit 120 in FIG. 1, the rapid start circuit 220 provides voltage Vcc to power converter 230 (or power converter IC) for powering SSL load 240 during a start-up period, until auxiliary winding 260 is fully charged and the voltage Vcc has a steady state value.

The rapid start circuit 220 receives (dimmed) rectified voltage Urect through diode bridge or bridge rectifier 210 from the dimmer via Dim Hot and Dim Neutral. When a dimming setting has been selected, the rectified voltage Urect has leading edge or trailing edge chopped waveforms, the extent of which is determined by the selected dimming setting, where low dimmer settings result in more significant waveform chopping and thus a lower RMS rectified voltage Urect. A rectified voltage Urect node N201 may be coupled to ground voltage through capacitor C211 (e.g., about 0.1 μF) in order to filter the switching current of the power converter.

The rectified voltage Urect is provided through the bridge rectifier 210 from a dimmer (not shown) via lines DIM hot and DIM neutral. The dimmer initially receives (undimmed) unrectified voltage from a power source via the power mains. Generally, the unrectified voltage is an AC line voltage signal having a voltage value, e.g., between about 90 VAC and about 277 VAC, and corresponding substantially sinusoidal waveforms. The dimmer includes an adjuster, which enables a dimming setting to be variably selected, e.g., manually by a user or automatically by a processor or other setting selection system. In an embodiment, the adjuster enables settings ranging from about 20 to 90 percent of the maximum light level of the SSL load 240, for example. Also, in various embodiments, the dimmer is a phase chopping (or phase cutting) dimmer, which chops either the leading edges or trailing edges of the input voltage waveforms, thereby reducing the amount of power reaching the SSL load 240.

The rapid start circuit 220 is particularly effective at very low dimming settings. According to the depicted representative embodiment, even when the rectified voltage Urect at Urect node N201 is very low (e.g., at the lowest dimmer setting), the rapid start circuit 220 avoids visible delay by lowering the capacitance from the voltage Vcc at Vcc node N202 to ground voltage during the start-up period, in addition to lowering resistance from the rectified voltage Urect at Urect node N201 to the voltage Vcc at Vcc node N202 during the start-up period. After the power converter 230 has started up, the auxiliary winding 260 provides the voltage Vcc to the power converter 230 through second diode 227 and third diode 250, discussed below.

More particularly, the rapid start circuit 220 shown in FIG. 2 includes the first diode 226 having a cathode connected to node N203 and an anode connected to a ground voltage. The rapid start circuit 220 also includes the transistor 225, having a base connected to node N203, a collector connected to Urect node N201 (rectified voltage Urect) through resistor R212 (e.g., about 5 kΩ), and an emitter connected to Vcc node N202 (voltage Vcc). Node N203 is also connected to Urect node N201 through resistor R211 (e.g., about 200 kΩ). The resistor R211 enables enough current to flow through the first diode 226 to keep the base of the transistor 225 slightly below the steady state voltage value of Vcc at Vcc node N202 when the voltage Vcc has been fully charged. However, when the voltage Vcc is below the voltage at the base of the transistor 225, such as during start up, the transistor 225 turns on, providing a low impedance path from the rectified voltage Urect to the voltage Vcc through the resistor R212 and the transistor 225, thus lowering the impedance from the rectified voltage node Urect N201 to the Vcc node N202 during the start-up transient, prior to the charging of the auxiliary winding 260.

In addition, rapid start circuit 220 includes the second diode 227, which separates the large bulk capacitance, capacitor C213 (e.g., about 10 μF), from the small bypass capacitance, capacitor C212 (e.g., about 0.1 μF), thereby reducing the total capacitance from Vcc node N202 to ground during the start-up transient. In an embodiment, the second diode 227 includes an anode connected to ground through the capacitor C213 and a cathode connected to ground through the capacitor C212.

When the mechanical switch on the dimmer (not shown) is turned on, the voltage from the auxiliary winding 260 is at or near ground voltage, assuming the SSL load 240 has been off for a sufficiently long time, and the second diode 227 is reverse biased. Because the resistor R211 biases the first diode 226, the transistor 225 turns on, allowing current to flow from rectified voltage Urect node N201 through the resistor R212 and the transistor 225 to Vcc node N202, as discussed above, initially charging only the capacitor C212 and not the capacitor C213, which has been effectively removed from the circuit by the second diode 227. Because the capacitor C212 is a small value capacitor used for bypassing Vcc node N202, the rapid start circuit 220 is able to charge the capacitor C212 to the operating voltage of the power converter 230 quickly, even when the rectified voltage Urect at Urect node N201 is very small, e.g., when the dimmer is at its lowest setting.

The large bulk capacitor C213 is not removed when Vcc is at the steady state voltage value, but only during the start-up period when the voltage at the auxiliary winding 260 is low. That is, in steady state, second diode 227 conducts, enabling the capacitor C213 to be connected to the voltage Vcc at Vcc node N202, providing the ripple reducing benefits of a large bulk capacitor. In addition, once the power converter 230 has started running, the transistor 225 is switched off because the first diode 226 is chosen to have a breakdown voltage slightly below the steady state voltage Vcc. In this manner, the second diode 227 effectively switches out the large bulk capacitance of the capacitor C213 during the start up transient, but allows it to be connected during steady state operation. By disconnecting the capacitor C213 during start-up, the voltage Vcc can be charged up faster, enabling rapid start even when the rectified voltage Urect is very low, such as when a dimmer is at its lowest setting.

It is understood that, although some representative values have been provided above for purposes of discussion, the values of the capacitors C211-C213 and the resistors R211-R212 are determined depending on the particular situation or application specific design requirements of various implementations, as would be apparent to one skilled in the art.

In the representative rapid start-up circuits described above with reference to FIGS. 1 and 2, a low impedance path is selectively provided to energize a power converter IC (e.g., power converter 130, 230) prior to the power converter IC energizing an auxiliary winding (e.g., auxiliary winding 160, 260) on the power magnetic to power itself. Once the auxiliary winding is energized and the power converter IC (and voltage Vcc) is in steady state, the low impedance path is removed, drawing no steady state power. Generally, the lower the impedance of the start up network, the faster the power converter IC will turn on. However, during steady state operation (e.g., after the start-up period), there are times that the solid state lighting unit or fixture draws insufficient current to sustain proper operation. Thus, according to various embodiments discussed below, the low impedance path of the rapid start-up circuit is selectively activated in response to this condition, multitasking the rapid start-up circuit to also act as a bleeder circuit.

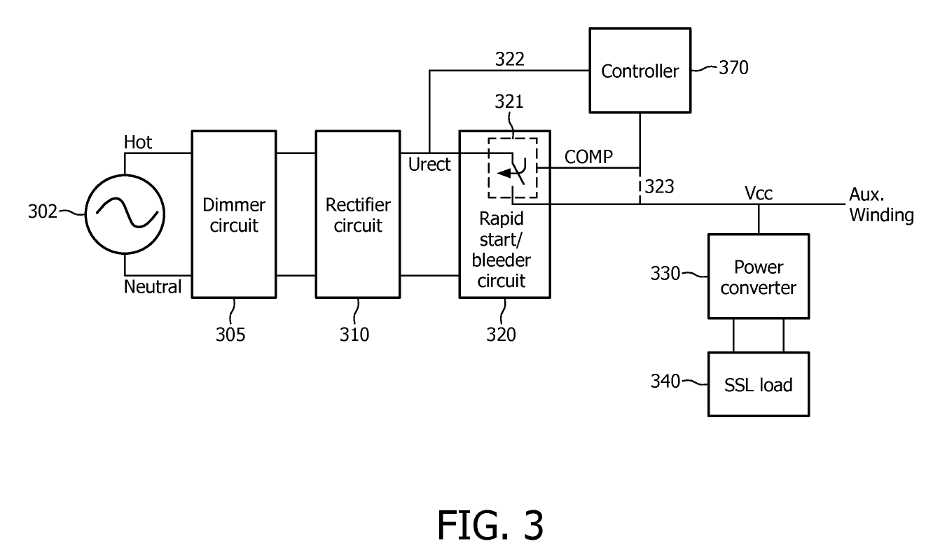

FIG. 3 is a block diagram showing a rapid start circuit multitasking as a bleeder circuit, according to a representative embodiment. Referring to FIG. 3, dimmer circuit 305 receives rectified voltage from power mains 302. The dimmer circuit 305 includes an adjuster (not shown), which enables a dimming setting to be variably selected, e.g., manually by a user or automatically by a processor or other setting selection system. In an embodiment, the adjuster enables settings ranging from about 20 to 90 percent of the maximum light level of the SSL load 340. Also, in various embodiments, the dimmer circuit 305 is a phase chopping (or phase cutting) dimmer, which chops either the leading edges or trailing edges of the input voltage waveforms, thereby reducing the amount of power reaching the SSL load 340. The rectifier circuit 310 rectifies the dimmed voltage (Urect) to be provided to the power converter 330 through the multitasking rapid start/bleeder circuit 320.

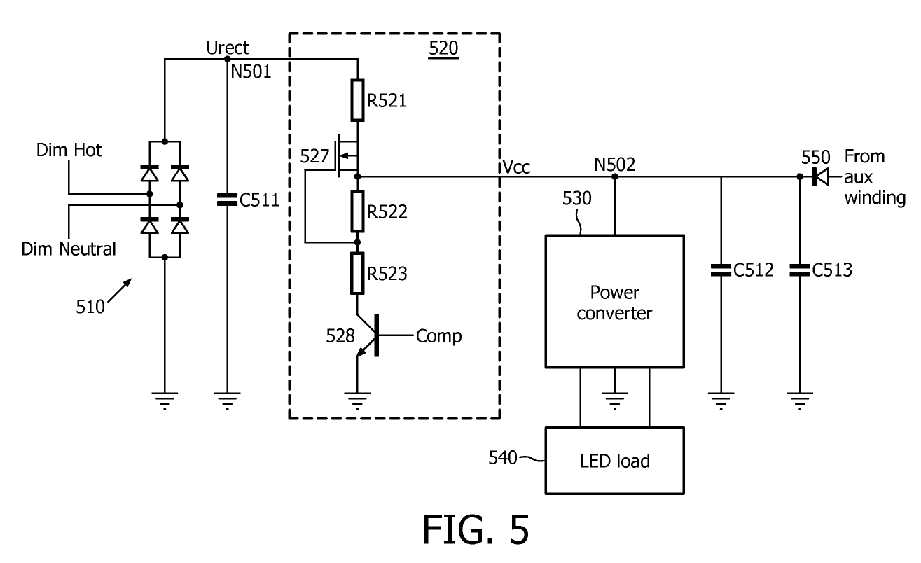

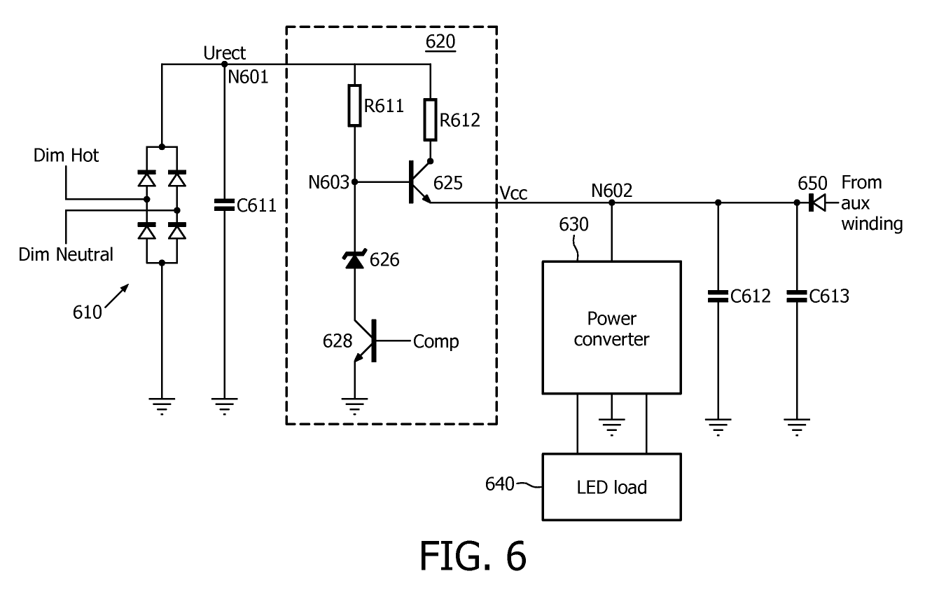

As described above, the rapid start/bleeder circuit 320 includes a selectable low impedance path 321. The selectable low impedance path 321 is indicated by a switch for convenience of explanation, where the low impedance path 321 is provided (switched in) when the switch is closed, and removed (switched out) when the switch is opened. The rapid start/bleeder circuit 320 and/or the low impedance path 321 may be implemented in various configurations without departing from the scope of the present teachings. For example, referring to FIGS. 1 and 2, the low impedance path 321 may include the resistor R121 and the first transistor 127 (in the on state) of the rapid start circuit 120 in FIG. 1, or the resistor R212 and the transistor 225 (in the on state) of the rapid start circuit 220 in FIG. 2. Other examples of the rapid start/bleeder circuit 320 and the low impedance path 321 are discussed below with reference to FIGS. 5 and 6.

In a representative embodiment, the low impedance path 321 is switched in to the circuit in response to a COMP signal. The COMP signal may be provided, for example, by controller 370. The controller 370 is configured to detect conditions in which the current drawn by the SSL load 340 is insufficiently low to enable proper operation of the SSL load 340. This condition may be indicated, for example, by the voltage level of voltage Vcc at the power converter 330 or the voltage level of the dimmed rectified voltage Urect output by the rectifier circuit 310. For example, the controller 370 may measure the level of the dimmed rectified voltage Urect via control line 322. When the voltage level of the dimmed rectified voltage Urect is below a predetermined threshold, which may be determined depending on the particular situation or application specific design requirements of various implementations, the controller 370 drives the COMP signal to a level enabling activation of the low impedance path 321. At other times, when the dimmed rectified voltage Urect is not below the predetermined threshold, the controller 370 drives the COMP signal to another level for deactivating the low impedance path 321. Alternatively, the controller 370 may measure current flow, e.g., through a current detector (not shown) at the SSL load 340. When the current flow is below a predetermined threshold or stops altogether, the controller drives the COMP signal to the level enabling activation of the low impedance path 321. Of course, the controller 370 may be configured to activate the low impedance path 321 based on various other triggers without departing from the scope of the present teachings. For example, the controller 370 may measure the on-time of the electronic switch (e.g., TRIAC or FET) of the dimmer circuit 305, and activate the low impedance path 321 following a predetermined amount of on-time (e.g., about 2.5 ms).

In an alternative embodiment, the COMP signal is not provided by the controller 370. Rather, the COMP signal may be generated by the rapid start/bleeder circuit 320 itself, e.g., based on feedback from Vcc node via optional signal line 323. For example, the rapid start/bleeder circuit 320 may be configured substantially the same as the representative rapid start circuit 120 in FIG. 1. Referring to FIG. 1, further to the initial start-up, the rectified voltage Urect is high and the voltage Vcc is charged to the necessary voltage, so that the power converter 130 powers the SSL load 140. Also, in this state, the COMP signal is high, which turns on the second transistor 128, connecting the gate of the first transistor 127 to ground voltage through the resistor R123, causing the first transistor 127 to turn off. Because the first transistor 127 is turned off, its impedance becomes high, which effectively disconnects the rectified voltage Urect at Urect node N101 from the Vcc node N102, e.g., effectively removing the low impedance path 321 from the circuit.

However, when voltage Vcc drops below an operational threshold and/or current drawn by the LED load 140 and power converter 130 drops to an inadequate level or stops altogether, the second transistor 128 is turned off by the low signal received at its base through the resistor R124, which is effectively the same as providing a low COMP signal. Once the second transistor 128 is turned off, the gate of the depletion first transistor 127 is connected to its source, for example, through resistor R122, creating a low impedance connection between the Urect node N101 and the Vcc node N102, e.g., effectively creating the low impedance path 321.

The rapid start/bleeder circuit 320 enables proper operation of the SSL load 340 to be maintained, even during periods of low voltage and/or insufficient current draw, without having to configure and control a separate bleeder circuit. Rather, the low impedance path 321 used for rapid start-up is likewise used selectively after start-up to draw current from the mains 302 to improve compatibility of the SSL load 340 and the dimmer circuit 305, when needed. That is, switching in the low impedance path 321, e.g., by turning on the second transistor 128 of FIG. 1, at appropriate times during all or part of the line cycle enables the low impedance path 321 to be used as a low impedance bleeder. Thus, according to various embodiments, no additional bleeder circuit is needed to make the SSL load 340 more compatible with dimmers. This approach is suitable in any instance where a non-resistive load is connected to a dimmer

There are a number of potential incompatibilities between the dimmer circuit 305 and the SSL load 340 that can be addressed by the selective activation of the low impedance path 321. For example, TRIAC switches are widely used as dimmer switches, particularly in households, because they typically are the least expensive solution. However, as discussed above, a TRIAC switch requires minimum holding and latching currents to correctly switch. For example, a dimmer such as a Lutron D-600PH dimmer, available from Lutron Electronics Co., Inc., may incorporate a BTA08-600BRG TRIAC, available from STMicroelectronics, which has a holding current and a latching current of about 50 mA. Thus, a minimum load of several watts (e.g., about 40 W) must be maintained for proper operation. As a result, such dimmers typically switch improperly (e.g., misfire) when used for low-wattage LED lamps and other SSL units and fixtures that provide small loads, particularly at lower dimmer settings. For example, eW Profile Powercore LED fixtures and eW Downlight Powercore LED fixtures, available from Philips Solid State Lighting Solutions, provide loads of only about 6 W and about 15 W, respectively. Therefore, the minimum holding and latching currents may not be maintained by the TRIAC switch.

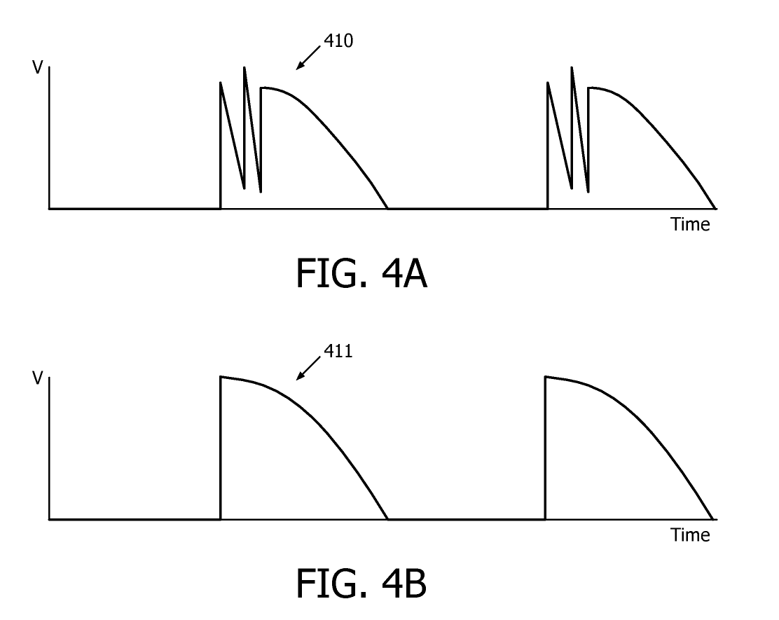

However, according to various embodiments, misfiring of a TRIAC switch can be detected by measuring the output voltage of the dimmer circuit 305 during operation, e.g., at the Urect node. FIG. 4A shows an example of a TRIAC switch misfiring. In particular, FIG. 4A shows a chopped, rectified voltage waveform 410 output by the dimmer circuit 305 connected to a low power SSL unit or fixture, such as SSL load 340. During each mains voltage half-wave, the TRIAC switch is fired multiple times. However, only once does this result in proper turn-on, indicated by the generally smooth sinusoidal curve at the trailing edge of the waveform 410. In the other attempts, the TRIAC switch snaps-off after almost immediately after triggering, and tries to turn on again a few milliseconds later. Visible flicker in the light output by the SSL unit or fixture results.

To prevent this condition, the low impedance path 321 of the multitasking rapid start/bleeder circuit 320 is selectably activated when current drawn by the SSL load 340 drops below a predetermined threshold. Thus, in the example of the TRIAC switch, the low impedance path 321 is temporarily created between the dimmer circuit 305 and the power converter 330, forcing the holding and latching currents of the TRIAC switch in the dimmer circuit 305 to be drawn and otherwise preventing the TRIAC switch from misfiring. FIG. 4B shows a representative chopped, rectified voltage waveform 411 output by the dimmer circuit 305 after creation of the low impedance path 321 of the rapid start/bleeder circuit 320.

Another example of potential incompatibility between the dimmer circuit 305 and the SSL load 340 occurs when the dimmer circuit 305 is set at low dimmer levels, resulting in a dimmed rectified voltage Urect too low for the power converter 330 to operate. For example, the output of the dimmer circuit 305 can be fairly low, e.g., about 35 V, and as a result, there is not enough energy transferred to the power magnetic for the auxiliary winding to power the power converter 330, resulting in shut down. However, according to various embodiments, the low impedance path 321 is switched in to supply the power converter 330 when the dimmed rectified voltage Urect is at too low of a voltage level. For example, the low voltage level is detected by the controller 370 and the low impedance path 321 is then switched in to supply the power converter 330 directly from the rectified mains of the rectifier circuit 310. Accordingly, the power converter 330 can run even during time periods when low voltage levels are output by the dimmer circuit 305.

Yet another example of incompatibility between the dimmer circuit 305 and the SSL load 340 results from capacitance when an electronic switch (not shown) of the dimmer circuit 305 is open (i.e., the switch is off). That is, when the dimmer electronic switch is open, the mains voltage is present across a capacitive divider consisting of a fixture input capacitor (not shown), connected to the Dim Hot line (between the dimmer circuit 305 and the rectifier circuit 310) and ground voltage, and a dimmer electromagnetic interference (EMI) capacitor (not shown), connected in parallel with the dimmer switch. Because the fixture input capacitor and the EMI capacitor may be near the same order of magnitude, some voltage is present across the power converter 330 from the impedance divider formed by the two aforementioned capacitors even when the dimmer switch is open, causing unstable operation. However, according to various embodiments, by switching in the low impedance path 321, a low impedance is created in parallel with the fixture input capacitor, and thus the voltage seen by the power converter 330 is reduced to an insignificant level.

FIGS. 5 and 6 are block diagrams showing rapid start circuits multitasking as bleeder circuits, according to representative embodiments. Referring to FIG. 5, rapid start/bleeder circuit 520 includes first (depletion) transistor 527, second transistor 528 and representative resistors R521-R523. For purposes of the following explanation, the first transistor 527 is a FET and the second transistor 528 is a BJT, although other types of transistors may be implemented without departing from the scope of the present teachings. The rapid start/bleeder circuit 520 provides voltage Vcc to power converter 530 (or power converter IC) to start the power converter 530 more quickly during a start-up period to begin delivering power from the mains to the SSL load 540, and after the start-up period, to deliver power from the mains to the SSL load 540 when the SSL load 540 is otherwise drawing insufficient current to enable normal operation. Capacitors C511-C513 and diode 550 are substantially the same as capacitors C111-C113 and diode 150 of FIG. 1, and therefore the descriptions will not be repeated with respect to FIG. 5.

The rapid start/bleeder circuit 520 receives (dimmed) rectified voltage Urect through diode bridge or bridge rectifier 510 from the dimmer (not shown) via Dim Hot and Dim Neutral. When a dimming setting has been selected, the rectified voltage Urect may have leading edge or trailing edge chopped waveforms, the extent of which is determined by the selected extent of dimming, where low dimmer settings result in more significant waveform chopping and thus a lower RMS rectified voltage Urect. A rectified voltage Urect node N501 may be coupled to ground voltage through capacitor C511 in order to filter the switching current of the power converter 530.

After start-up and during normal operation of the SSL load 540 and/or normal voltage levels at Urect node N501, the COMP signal received at the base of the second transistor 528 is at a first level (e.g., a high level), e.g., as provided by the controller 370 (not shown in FIG. 5). In the depicted representative embodiment, the second transistor 528 also includes a collector connected to resistor R523 (e.g., about 100 kΩ). In response to the high COMP signal at its base, the second transistor 528 is turned on, connecting the gate of the first transistor 527 to ground voltage through the resistor R523. In this state, the first transistor 527 is turned off, and its impedance becomes high, which effectively disconnects the rectified voltage Urect at Urect node N501 from the Vcc node N502, thus removing the low impedance path, including the resistor R521 (e.g., about 22 kΩ) and the first transistor 527, from between the Urect node N501 and the Vcc node N502.

However, due to the low power of the SSL load 540, the current drawn by the SSL load 540 may stop or otherwise drop below a predetermined level during normal operation. This condition may be detected, for example, by continually or periodically measuring the dimmed rectified voltage at Urect node N501 and comparing the measured voltage to a predetermined threshold value (e.g., using the controller 370), which corresponds to the inadequate current levels. In response, the COMP signal is set to a second level (e.g., a low level), e.g., as provided by the controller 370. In the depicted representative embodiment, the second transistor 528 is turned off in response to the low COMP signal, disconnecting the gate of the first transistor 527 from ground voltage and connecting the gate of the first transistor 527 to the source of the first transistor 527 through resistor R522 (e.g., about 100 kΩ). In this state, the impedance of the depletion first transistor 527 becomes low. A drain of the first transistor 527 is connected to Urect node N501 through resistor R521. Thus, a low impedance path is created between the Urect node N501 and the Vcc node N502, including the resistor R521 and the first transistor 527. In other words, when the COMP signal is low, the rectified voltage Urect at Urect node N501 is connected to the Vcc node N202 through the low impedance path, and when the COMP signal high, the low impedance path is disconnected.

Referring to FIG. 6, rapid start/bleeder circuit 620 includes first transistor 625, second transistor 628, first diode 626 (e.g., a zener diode) and representative resistors R611-R612. For purposes of the following explanation, the first and second transistors 625 and 628 are BJTs, although other types of transistors may be implemented without departing from the scope of the present teachings. The rapid start/bleeder circuit 620 provides voltage Vcc to power converter 630 to start the power converter 630 more quickly during a start-up period to begin delivering power from the mains to the SSL load 640, and after the start-up period, to deliver power from the mains to the SSL load 640 when the SSL load 640 is otherwise drawing insufficient current to enable normal operation. Capacitors C611-C613 and second diode 650 are substantially the same as capacitors C211-C213 and diode 250 of FIG. 2, and therefore the descriptions will not be repeated with respect to FIG. 6. The rapid start/bleeder circuit 620 receives (dimmed) rectified voltage Urect through diode bridge or bridge rectifier 610 from the dimmer (not shown) via Dim Hot and Dim Neutral, as discussed above.

The first diode 626 has a cathode connected to node N603 and an anode connected to the second transistor 628. The first transistor 625 includes a base also connected to node N603, a collector connected to Urect node N601 (rectified voltage Urect) through resistor R612 (e.g., about 5 kΩ), and an emitter connected to Vcc node N602 (voltage Vcc). Node N603 is also connected to Urect node N601 through resistor R611 (e.g., about 200 kΩ). After start-up and during normal operation of the SSL load 640 and/or normal voltage levels at Urect node N601, the COMP signal received at the base of the second transistor 628 is at a first level (e.g., a high level), e.g., as provided by the controller 370 (not shown in FIG. 6).

In the depicted representative embodiment, the second transistor 628 also includes a collector connected to the anode of the first diode 626 and an emitter connected to ground voltage. In response to the high COMP signal at its base, the second transistor 628 is turned on, connecting the anode of the first diode 626 to ground voltage enabling normal operation. In this state, the resistor R611 enables enough current to flow through the first diode 626 to keep the base of the transistor 625 slightly below the steady state voltage value of Vcc at Vcc node N602 when the voltage Vcc has been fully charged at start-up or when the SSL load 640 is otherwise drawing sufficient current. The low impedance path, including the resistor R612 and the first transistor 625, is therefore not formed between the Urect node N601 and the Vcc node N602.

However, when the voltage Vcc is below the voltage at the base of the transistor 625, such as during start-up or when the SSL load 640 is not drawing sufficient current, the first transistor 625 turns on, providing a low impedance path from the rectified voltage Urect to the voltage Vcc through the resistor R612 and the transistor 625, thus lowering the impedance from the rectified voltage node Urect N601 to the Vcc node N602. In addition, this condition is detected, for example, by continually or periodically measuring the dimmed rectified voltage at Urect node N601 and comparing the measured voltage to a predetermined threshold value (e.g., using the controller 370), which corresponds to the inadequate current levels. Accordingly, the COMP signal is set to a second level (e.g., a low level), which turns off the second transistor 628, disconnecting the anode of the first diode 626 from ground voltage and further causing 625 to turn on to provide the low impedance path from the rectified voltage Urect to the voltage Vcc through the resistor R612 and the transistor 625. Thus, in steady state, when Vcc is fed from the auxiliary winding, when the COMP signal is low, the rectified voltage Urect at Urect node N601 is connected to the Vcc node N602 through the low impedance path, and when the COMP signal high, the low impedance path is disconnected. In other words, in the depicted embodiment, when the COMP signal is low, the bleeder is always activated.

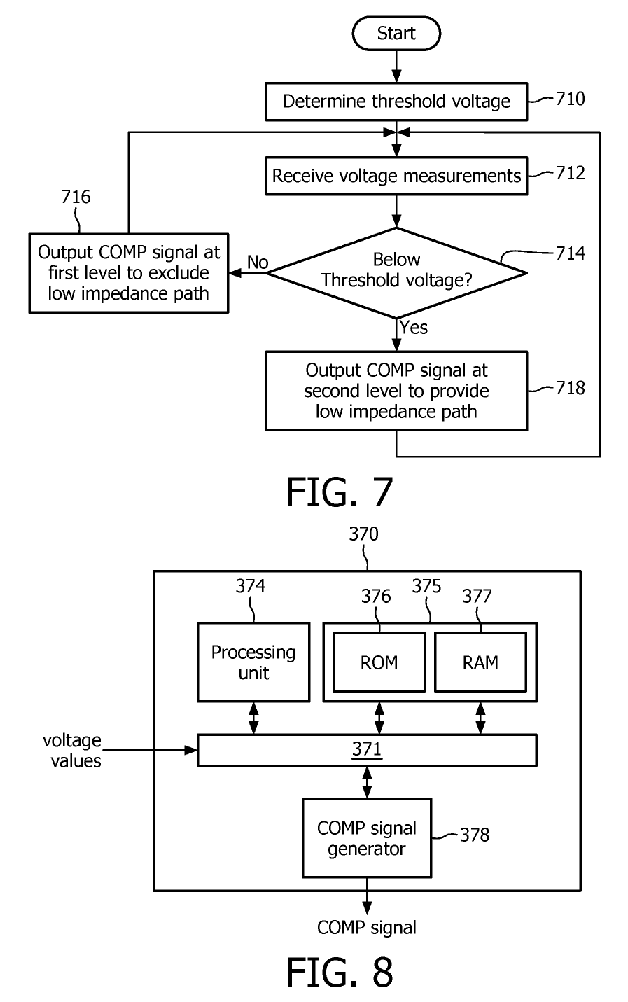

FIG. 7 is a flow diagram showing a process of implementing a low impedance path of a rapid start circuit as a bleeder circuit, according to a representative embodiment. Referring to FIGS. 3 and 7, the controller 370 determines the threshold voltage of the dimmed rectified voltage Urect, which triggers activation of the low impedance path 321, in block 710. The threshold voltage may be determined, for example, based on the type of dimmer circuit 305 and/or the corresponding dimmer setting, the type of SSL load 340 and/or corresponding power requirements, or other factors indicating at what voltage the SSL load 340 will stop drawing current or otherwise begin functioning incorrectly. The controller 370 may access a previously stored look-up table, for example, associating various dimmer circuits, dimmer settings, SSL loads, and the like, with corresponding threshold voltages. As discussed above, triggers other than the value of the dimmed rectified voltage Urect may be used to determine when to activate the low impedance path 321, without departing from the scope of the present teachings.

In block 712, the controller 370 receives voltage measurements from the rectifier circuit 310, indicating the value of the dimmed rectified voltage Urect. The controller 370 compares the measured voltage to the threshold voltage in block 714. When the measured voltage is not below the threshold voltage (block 714: No), indicating that the power converter 330 and the SSL load 340 are functioning properly, the controller 370 outputs the COMP signal having a first (e.g., high) level in order to deactivate the low impedance path 321. When the measured voltage is below the threshold voltage (block 714: Yes), indicating that the power converter 330 and/or the SSL load 340 are not functioning properly, the controller 370 outputs the COMP signal having a second (e.g., low) level in order to activate the low impedance path 321, causing the rapid start/bleeder circuit 320 to function as a bleeder circuit.

FIG. 8 is a block diagram of controller 370, according to a representative embodiment. Referring to FIG. 8, the controller 370 includes processing unit 374, read-only memory (ROM) 376, random-access memory (RAM) 377 and COMP signal generator 378.

As discussed above, the controller 370 receives voltage values, e.g., indicating the rectified dimmed voltage Urect at node Urect. More particularly, the voltage values may be received by the processing unit 374 for processing, and also may be stored in ROM 376 and/or RAM 377 of memory 375, e.g., via bus 371. The processing unit 374 may include its own memory (e.g., nonvolatile memory) for storing executable software/firmware executable code that allows it to perform the various functions of the controller 370. Alternatively, the executable code may be stored in designated memory locations within the memory 375.

As discussed above, the controller 370 can be implemented in numerous ways (e.g., such as with dedicated hardware) to perform the various functions discussed above. A “processor,” such as the processing unit 374, is one example of the controller 370, which may employ one or more microprocessors that may be programmed using software (e.g., microcode) to perform various functions discussed herein. However, the controller 370 may be implemented without employing a processor, and also may be implemented as a combination of dedicated hardware to perform some functions and a processor (e.g., one or more programmed microprocessors and associated circuitry) to perform various functions. Examples of controller components that may be employed in various embodiments of the present disclosure include, but are not limited to, conventional microprocessors, ASICs and FPGAs.

The memory 375 may be any number, type and combination of nonvolatile ROM 376 and volatile RAM 377, and stores various types of information, such as signals and/or computer programs and software algorithms executable by the processing unit 374 (and/or other components), e.g., to provide control of the rapid start/bleeder circuit 320 according to various embodiments. As generally indicated by ROM 376 and RAM 377, the memory 375 may include any number, type and combination of tangible computer readable storage media, such as a disk drive, a PROM, an EPROM, an EEPROM, a CD, a DVD, a USB drive, and the like. Further, the memory 375 may store the predetermined threshold voltage and/or currents associated with various types of SSL units or fixtures (e.g., SSL load 340), various types of dimmer circuits 305 and/or dimmer setting, as discussed above. In some implementations, the ROM 376 and/or RAM 377 storage media may be encoded with one or more programs that, when executed by the processing unit 374, perform all or some of the functions of the controller 370, discussed herein.

The COMP signal generator 378 generates and outputs a signal having one of two levels (e.g., high and low) as the COMP signal, in response to instructions or control signals from the processing unit 374. For example, the COMP signal generator 378 may output a low level signal whenever the processing unit 374 determines that the dimmed rectified voltage Urect drops below the predetermined threshold value during normal operation of the SSL unit or fixture, as discussed above, activating the low impedance path 321 through the rapid start/bleeder circuit 320. Otherwise, the COMP signal generator 378 outputs a high level signal when the processing unit 374 determines that the dimmed rectified voltage Urect is above the predetermined threshold value.

The various “parts” shown in the controller 370 may be physically implemented using a software-controlled microprocessor (e.g., processing unit 374), hard-wired logic circuits, firmware, or a combination thereof. Also, while the parts are functionally segregated in the representative controller 370 for explanation purposes, they may be combined variously in any physical implementation.

In various embodiments, operations corresponding to the blocks of FIG. 7 may be implemented as processing modules executable by a device, such as the controller 370 and/or the processing unit 374 of FIG. 8, according to a representative embodiment. The processing modules may be part of the controller 370 and/or the processing unit 374, for example, and may be implemented as any combination of software, hard-wired logic circuits ware and/or firmware configured to perform the designated operations. Software modules, in particular, may include source code written in any of a variety of computing languages, such as C++, C# or Java, and are stored on tangible computer readable storage media, such the computer readable storage media discussed above with respect to memory 375, for example.

While multiple inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein.

More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited. In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of and “consisting essentially of shall be closed or semi-closed transitional phrases, respectively, as set forth in the United States Patent Office Manual of Patent Examining Procedures, Section 2111.03.

What is claimed is:

1. A device for controlling current drawn by a solid state lighting (SSL) fixture, including a power converter and an SSL load, the device comprising:
a rapid start/bleeder circuit comprising a selectable low impedance path, configured to be temporarily activated to form a low impedance connection between a voltage rectifier and the power converter providing power to the solid state lighting load, wherein the low impedance path is temporarily activated during a start-up period to charge the power converter and during times other than the start-up period based on detected improper operation of the SSL fixture.

2. The device of claim 1, wherein the rapid start/bleeder circuit further comprises:
a first transistor connected between the voltage rectifier and the power converter, the low impedance path including the first transistor when the first transistor is turned on; and
a second transistor connected between the first transistor and a ground voltage, the second transistor being turned off in response to a control signal, turning on the first transistor.

3. The device of claim 2, further comprising:
a controller configured to provide the control signal to the second transistor, the control signal having a first level to turn on the second transistor and a second level to turn off the second transistor.

4. The device of claim 3, wherein the controller provides the control signal having the second level when a voltage at the power converter is less than a steady state value during the start-up period and when an amount of current drawn by the solid state lighting load is less than a minimum value during times other than the start-up period.

5. The device of claim 4, wherein the controller provides the control signal having the first level when the voltage at the power converter is greater than or equal to the steady state value during the start-up period and when the amount of current drawn by the solid state lighting load is greater or equal to the minimum value during times other than the start-up period, deactivating the low impedance path.

6. The device of claim 2, wherein the first transistor comprises a field effect transistor (FET) and the second transistor comprises a bipolar junction transistor (BJT).

7. The device of claim 1, wherein the rapid start/bleeder circuit further comprises a diode connected between the power converter and an auxiliary winding, the diode comprising a cathode connected to the ground voltage through a first capacitor having a small bypass capacitance and an anode connected to the ground voltage through a second capacitor having a large bulk capacitance.

8. The device of claim 7, wherein the first capacitor is charged and the second capacitor is not charged while the low impedance path is formed.

9. The device of claim 1, wherein the rapid start/bleeder circuit further comprises:
a first transistor connected between the rectified voltage node and the power converter voltage node, the low impedance path comprising the transistor when the transistor is turned on;
a zener diode comprising a cathode connected to the first transistor and the voltage rectifier; and
a second transistor connected between an anode of the zener diode and a ground voltage, the second transistor being turned off in response to a control signal, turning on the first transistor.

10. The device of claim 9, further comprising:
a first resistor connected between the first transistor and the voltage rectifier, the low impedance path further comprising the first resistor when the first transistor is turned on; and
a second resistor connected between the cathode of the zener diode and the voltage rectifier.

11. The device of claim 10, further comprising:
a controller configured to provide the control signal to the second transistor, the control signal having a first level to turn on the second transistor and a second level to turn off the second transistor.

12. The device of claim 11, wherein the controller provides the control signal having the second level when a voltage at the power converter is less than a steady state value during the start-up period and when an amount of current drawn by the solid state lighting load is less than a minimum value during times other than the start-up period.

13. The device of claim 12, wherein the controller provides the control signal having the first level when the voltage at the power converter is greater than or equal to the steady state value during the start-up period and when the amount of current drawn by the solid state lighting load is greater or equal to the minimum value during times other than the start-up period, deactivating the low impedance path.

14. The device of claim 9, wherein the first and second transistors comprise bipolar junction transistors (BJTs).

15. A system for powering a solid state lighting load, the system comprising:
a dimmer circuit configured to adjust a voltage of the solid state lighting load;
a rectifier circuit configured to rectify the adjusted voltage output by the dimmer circuit;
a power converter configured to provide power to the solid state lighting load based on the rectified voltage output by the rectifier circuit;
a rapid start/bleeder circuit comprising a low impedance path, configured to form a low impedance connection between the rectifier circuit and the power converter when activated; and
a controller configured to selectively activate the low impedance path of the rapid start/bleeder circuit during a start-up period to charge the power converter and during times other than the start-up period based on current drawn by the solid state lighting load.

16. The system of claim 15, wherein the controller is configured to selectively activate the low impedance path during times other than the start-up period when the current drawn by the solid state lighting load is less than a minimum required current.

17. The system of claim 16, wherein the controller determines when the current drawn by the solid state lighting load is less than the minimum required current by comparing the rectified voltage output by the rectifier circuit with a predetermined threshold voltage, the controller selectively activating the low impedance path when the rectified voltage is less than the threshold voltage.

18. The system of claim 16, wherein the controller activates the low impedance path when an on-time of an electronic switch in the dimmer circuit is greater than a predetermined threshold time.

19. The system of claim 16, wherein the rapid start/bleeder circuit further comprises:
a first transistor connected between the rectifier circuit and the power converter, the low impedance path including the first transistor when the first transistor is turned on; and
a second transistor connected between the first transistor and a ground voltage, the second transistor being turned off in response to the control signal, turning on the first transistor, to selectively activate the low impedance path.

20. A system comprising:
a dimmer configured to adjust an input voltage;
a rectifier configured to rectify the adjusted voltage output by the dimmer circuit;
a solid state lighting (SSL) fixture including a power converter and an SSL load, the power converter providing power to the SSL based on the rectified voltage output by the rectifier;
a rapid start/bleeder circuit comprising a low impedance path, configured to form a low impedance connection between the rectifier circuit and the power converter when activated; and
a controller configured to monitor operation of the SSL fixture and to selectively activate the low impedance path of the rapid start/bleeder circuit during a start-up period to charge the power converter and during times other than the start-up period based on the monitoring of the SSL fixture operation.
